(19) United States
(12) Patent Application Publication
(10) Pub. No.: US 2020/0342867 A1
(43) Pub. Date: Oct. 29, 2020

(54) TELEVISION DESKTOP DISPLAY METHOD AND APPARATUS

(71) Applicant: BAIDU ONLINE NETWORK TECHNOLOGY (BEIJING) CO., LTD., BEIJING (CN)

(72) Inventor: SHUHAN LUAN, BEIJING (CN)

(21) Appl. No.: 16/703,611

(22) Filed: Dec. 4, 2019

(30) Foreign Application Priority Data
Apr. 28, 2019 (CN) 201910349528.2

(51) Int. Cl. G10L 15/22; G06F 3/14; G06F 3/16; G10L 15/08

(52) U.S. Cl. CPC G10L 15/22; G06F 3/14; G10L 2015/088; G10L 15/08; G10L 2015/223; G06F 3/167

(57) ABSTRACT

The present disclosure provides a television desktop display method and apparatus, where, the television desktop display method includes: receiving desktop display instruction; acquiring multiple desktops and display time corresponding to the multiple desktops respectively according to the desktop display instruction; and displaying the multiple desktops circularly according to the display time corresponding to the multiple desktops respectively. In the process of displaying television desktops, displaying the multiple desktops circularly according to the display time corresponding to the multiple desktops respectively enable the user to continuously browse the television desktops in a recommendation form of continuous automatic browsing, thereby improving human-machine interaction effect.

### CROSS-REFERENCE TO RELATED APPLICATION

This application claims priority to Chinese Patent Application CN201910349528.2, filed on Apr. 28, 2019, which is incorporated by reference in its entirety.

### TECHNICAL FIELD

The present disclosure relates to the field of smart household appliances technology and, in particular, to a television desktop display method and apparatus.

### BACKGROUND

With the continuous development of science and technology, the television has gradually become increasingly smart. A smart television can realize bi-directional human-machine interaction functions, integrating functions like audio-visual, entertainment, data and so on, which satisfy diversified and personalized requirements of users.

Currently, the smart television is usually controlled via a remote controller, and a television desktop is also designed for the interaction based on clicking the remote controller. For example, a home page is displayed when a television is turned on. The user can click the up, down, left or right button on the remote controller to issue control instructions to the smart television, thus a switch between different television desktops can be realized.

However, the user needs to manipulate the remote controller all the time when realizing control of the television desktop through the remote controller, which reduces human-machine interaction effect.

### SUMMARY

The present disclosure provides a television desktop display method and a television desktop apparatus, which improve the human-machine interaction effect.

In a first aspect, the present disclosure provides a television desktop display method, including:

receiving desktop display instruction;

acquiring multiple desktops and display time corresponding to the multiple desktops respectively according to the desktop display instruction;

displaying the multiple desktops circularly according to the display time corresponding to the multiple desktops respectively.

In one possible implementation of the first aspect, the desktop includes voice guidance information, the voice guidance information is used to guide a user to input voice instruction.

In one possible implementation of the first aspect, further including:

receiving voice wake-up words input by a user when a first desktop is currently displayed;

if voice instructions input by the user is received within a preset time period after being woken up, stopping displaying the multiple desktops circularly and processing the voice instructions.

In one possible implementation of the first aspect, further including:

if the voice instruction input by the user is not received within the preset time period after being woken up, continuing displaying the multiple desktops circularly.

In one possible implementation of the first aspect, the acquiring multiple desktops and display time corresponding to the multiple desktops respectively according to the desktop display instruction, including:

acquiring a desktop display rule according to the desktop display instruction;

acquiring the multiple desktops and the display time corresponding to the multiple desktops respectively according to the desktop display rule.

In one possible implementation of the first aspect, the acquiring the multiple desktops and the display time corresponding to the multiple desktops respectively according to the desktop display rule, including:

acquiring multiple display themes and a hit rate corresponding to each display theme according to the desktop display rule, the hit rate is used to indicate a probability that a user chooses the display theme;

acquiring the multiple desktops and the display time corresponding to the multiple desktops respectively according to the multiple display themes, the hit rate corresponding to each display theme and preset desktop display templates, where the desktop includes at least one of the display themes.

In one possible implementation of the first aspect, the acquiring display time corresponding to multiple desktops respectively, including:

determining the display time of the desktop display templates corresponding to the multiple desktops respectively as the display time corresponding to the multiple desktops respectively.

In one possible implementation of the first aspect, the desktop display rule includes at least one of the followings: displaying according to a default display desktop, displaying according to historical viewing information of a user, displaying according to historical search information of a user, displaying according to preference information of a user, and displaying according to user portrait information of a user.

In a second aspect, the present disclosure provides a television desktop display apparatus, including:

a receiving module, configured to receive desktop display instruction;

an acquiring module, configured to acquire multiple desktops and display time corresponding to the multiple desktops respectively according to the desktop display instruction;

a controlling module, configured to display the multiple desktops circularly according to the display time corresponding to the multiple desktops respectively.

In one possible implementation of the second aspect, the desktop includes voice guidance information, the voice guidance information is used to guide a user to input voice instruction.

In one possible implementation of the second aspect, the receiving module is further configured to receive voice wake-up words input by a user when a first desktop is currently displayed;

the controlling module is further configured to, if voice instruction input by the user is received within a preset time period after being woken up, stop displaying the multiple desktops circularly and process the voice instruction.

In one possible implementation of the second aspect, the controlling module is further configured to:

if the voice instruction input by the user is not received within the preset time period after being woken up, continue displaying the multiple desktops circularly.

In one possible implementation of the second aspect, the acquiring module is specifically configured to:

acquire a desktop display rule according to the desktop display instruction;

acquire the multiple desktops and the display time that corresponding to the multiple desktops respectively according to the desktop display rule.

In one possible implementation of the second aspect, the acquiring module is specifically configured to:

acquire multiple display themes and a hit rate corresponding to each display theme according to the desktop display rule, the hit rate is used to indicate a probability that a user chooses the display theme;

acquire the multiple desktops and the display time corresponding to the multiple desktops respectively according to the multiple display themes, the hit rate corresponding to each display theme and preset desktop display templates; where, the desktop includes at least one of the display themes.

In one possible implementation of the second aspect, the acquiring module is specifically configured to:

determine the display time of the desktop display templates corresponding to the multiple desktops respectively as the display time corresponding to the multiple desktops respectively.

In one possible implementation of the second aspect, the desktop display rule includes at least one of the followings: displaying according to a default display desktop, displaying according to historical viewing information of a user, displaying according to historical search information of a user, displaying according to preference information of a user, and displaying according to user portrait information of a user.

In a third aspect, the present disclosure provides a television desktop display apparatus, including: a memory and a processor;

the memory is configured to store program instructions;

the processor is used to invoke the program instructions stored in the memory to implement the television desktop display method provided by any implementations of the first aspect.

In a forth aspect, the present disclosure provides a storage medium, including a readable storage medium and a computer program, the computer program is used to implement the television desktop display method provided by any implementations of the first aspect.

According to the television desktop display method and apparatus provided by the present disclosure, in the process of displaying television desktops, displaying the multiple desktops circularly according to the display time corresponding to the multiple desktops respectively enable the user to continuously browse the television desktops in a recommendation form of continuous automatic browsing by taking the desktop as a switch unit, thereby improving human-machine interaction effect and user experience.

### BRIEF DESCRIPTION OF DRAWINGS

In order to illustrate embodiments of the present disclosure or technical solutions in the prior art more clearly, the appended drawings needed to be used in the description of the embodiments or the prior art will be briefly illustrated below, and obviously, the appended drawings in the description below are some embodiments of the present disclosure, and for those skilled in the art, other appended drawings may be obtained according to these appended drawings without creative effort.

FIG. 1 is a schematic structural diagram of a television system applicable to the present disclosure;

FIG. 2 is a flowchart of a television desktop display method provided by an embodiment of the present disclosure;

FIG. 3 is a schematic diagram of a desktop provided by an embodiment of the present disclosure;

FIG. 4 is another schematic diagram of a desktop provided by an embodiment of the present disclosure;

FIG. 5 is a schematic structural diagram of a television desktop display apparatus provided by Embodiment 1 of the present disclosure; and

FIG. 6 is a schematic structural diagram of a television desktop display apparatus provided by Embodiment 2 of the present disclosure.

### DESCRIPTION OF EMBODIMENTS

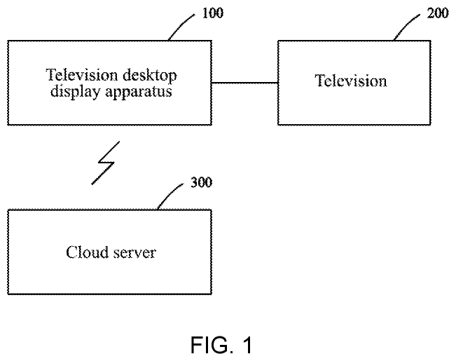

FIG. 1 is a schematic structural diagram of a television system applicable to the present disclosure. As shown in FIG. 1, a television system may include a television desktop display apparatus 100 and a television 200. In an implementation, the television system may also include a cloud server 300. The present disclosure does not make limitation to the connection manner between the television desktop display apparatus 100 and the television 200, or the connection manner between the television desktop display apparatus 100 and the cloud server 300. For example, the television desktop display apparatus 100 and the television 200 may be connected by wire or wireless. The television desktop display apparatus 100 and the cloud server 300 may be wireless connected. The present disclosure does not make limitation to the wire or wireless connection manners.

In which, the television desktop display apparatus 100 may receive interaction information input by a user, and control the television 200 to display correspondingly according to the interaction information. The present disclosure does not make limitation to the implementation of processing the interaction information by the television desktop display apparatus 100. In an implementation, the television desktop display apparatus 100 may process the interaction information to obtain a processing result, and control the television 200 to display correspondingly according to the processing result. In an implementation, the television desktop display apparatus 100 may send the interaction information to the cloud server 300. Accordingly, the cloud server 300 may process the interaction information to obtain the processing result, and send the processing result to the television desktop display apparatus 100. The television desktop display apparatus 100 may control the television 200 to display according to the processing result. The present disclosure does not make limitation to the interaction information input by the user. For example, the user may input voice information to the television desktop display apparatus 100. The television desktop display apparatus 100 may send the voice information to the cloud server 300. The cloud server 300 may obtain voice instructions by identifying the voice information, and then obtain processing result according to the voice instruction.

It should be noted that, the present disclosure does not make limitation to the specific model or implementation of the television 200, or the shape, structure or implementation of the television desktop display apparatus 100. In an implementation, the television desktop display apparatus 100 may include a housing and a processor, a memory, a sound collecting apparatus, a sound emitting apparatus, a transceiver and the like that set in the housing. The sound collecting apparatus may be used to obtain the voice information input by the user. The transceiver may be used to send the voice information to the cloud server 300, and receive the processing result from the cloud server 300. The processor may be used to control the television 200 to display. The sound emitting apparatus may be used to play voice data. The present disclosure does not make limitation to the implementation of any apparatus. For example, the sound collecting apparatus may be a microphone array or include at least one microphone. For example, the sound emitting apparatus may include at least one speaker.

The technical solutions in the embodiments of the present disclosure are illustrated clearly and completely below in combination with the appended drawings in the embodiments of the present disclosure, and obviously, the embodiments described are merely part of the embodiments of the present disclosure but not all the embodiments. Other embodiments obtained by those ordinary skilled in the art without creative labor based on the embodiments in the present disclosure are within the scope of the protection of the present disclosure.

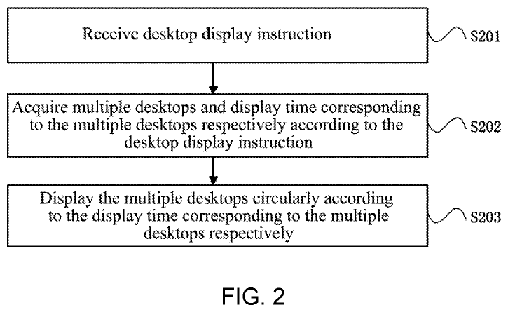

FIG. 2 is a flowchart of a television desktop display method provided by an embodiment of the present disclosure. The entity performing the television desktop display method provided by the present disclosure may be a television desktop display apparatus. As shown in FIG. 2, the television desktop display method provided by an embodiment of the present disclosure may include:

S201, receiving desktop display instruction.

The desktop display instruction is used to instruct to display a desktop on the television screen.

The implementations of receiving the desktop display instruction are illustrated below.

In one implementation, the desktop display instruction is received when the television desktop display apparatus is initially powered on.

Specifically, the implementation relates to a scenario that the television desktop display apparatus is initially powered on. The desktop display instruction may be received when the television desktop display apparatus is detected to be initially powered on.

In another implementation, the desktop display instruction is received when the television desktop display apparatus changes from a standby state to a working state.

Specifically, the implementation relates to two states of the television desktop display apparatus, which are the standby state and the working state. The standby state refers to a state that the television desktop display apparatus is powered on but without any substantive data processing. The desktop display instruction is received when the television desktop display apparatus changes from the standby state to the working state. The present embodiment does not make limitation to the manner of triggering the television desktop display apparatus to change from the standby state to the working state. In an implementation, the first voice instruction input by the user or the first control instruction sent by a remote controller may be received, where the first voice instruction or the first control instruction is used to instruct the television desktop display apparatus to change from the standby state to the working state.

In another implementation, the desktop display instruction is received when the second voice instruction input by the user or the second control instruction sent by the remote controller is received. Where, the second voice instruction or the second control instruction is used to instruct to return back to the display desktop.

Specifically, the implementation relates to the scenario of returning back to the display desktop in a normal working state. For example, when a television is playing a drama, it may receive the desktop display instruction when the user says “hello, stop playing, and return back to the home page”. For another example, when a television is playing a drama, it may receive the desktop display instruction when the user presses the “menu” button on the remote controller.

S202, acquiring multiple desktops and display time that corresponding to the multiple desktops respectively according to the desktop display instruction.

Specifically, the multiple desktops may be acquired after receiving the desktop display instructions. Each desktop has a corresponding display time. The display time of the desktop is used to indicate dwell time of the desktop. For example, if the display time corresponding to the desktop is 10 s, then the desktop will be displayed continuously for 10 s when it is displayed. The present embodiment does not make limitation to the specific value of the display time corresponding to the desktop. In an implementation, the display time corresponding to the multiple desktops respectively may be the same or different.

S203, displaying the multiple desktops circularly according to the display time corresponding to the multiple desktops respectively.

Specifically, since each desktop has a corresponding display time, the multiple desktops may be displayed circularly according to the display time corresponding to the multiple desktops respectively. For example as below, 5 desktops are acquired and marked as desktop 1 to desktop 5, of which the corresponding display time is respectively 10 s, 5 s, 5 s, 3 s, and 3 s. Assuming that the desktops are displayed in an order from the desktop 1 to the desktop 5, then the desktops are displayed automatically in an order that: displaying the desktop 1 for 10 s, displaying the desktop 2 for 5 s, displaying the desktop 3 for 5 s, displaying the desktop 4 for 3 s, displaying the desktop 5 for 3 s, displaying the desktop 1 for 10 s, displaying the desktop 2 for 5 s, . . . , thus displaying the multiple desktops circularly is achieved.

It should be noted that, the present embodiment does not make limitation to the order of displaying the multiple desktops.

It can be seen that, according to the television desktop display method provided by the present embodiment, in the scenario of displaying the television desktops, the multiple desktops may be displayed circularly according to the display time corresponding to multiple desktops respectively through acquiring the display time corresponding to each desktop respectively. In the process of displaying the television desktops, the user doesn't need to frequently operate the remote controller or frequently perform the human-machine interaction, the recommendation form of continuous infinite automatic browsing by taking the desktop as a switch unit may be achieved, which enables the user to browse the television desktops continuously without any interaction, thereby improving human-machine interaction effect and user experience.

It should be noted that, the present embodiment does not make limitation to the implementations of desktops and the specific contents included in the desktops. For example, the desktop may be a two-dimension picture. Alternatively, the desktop may be an existing type of desktop.

In an implementation, the desktop may include voice guidance information, where the voice guidance information is used to guide the user to input voice instructions.

Specifically, a voice interaction mode between the user and the device can be achieved through setting voice guidance information on the desktop and combining the voice guidance information with content displayed on the desktop, so as to guide the user to input correct voice instructions and thus interact with the content displayed on the desktop. When the user hits the displayed content through the voice interaction mode, the displayed table will be automatically changed to the corresponding content. Compared with the interaction by using the remote controller, realizing the human-machine interaction through a mode of human-machine conversation by the user further improves the human-machine interaction effect and the interaction efficiency, and improves user experience.

It should be noted that, the present embodiment does not make limitation to the implementations of the voice guidance information and the specific contents included therein. For example, the voice guidance information may include at least one of the followings: words and videos. The desktops and the voice guidance information is described below by using examples.

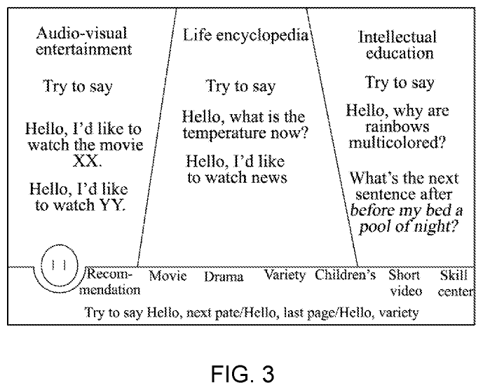

FIG. 3 is a schematic diagram of a desktop provided by an embodiment of the present disclosure. As shown in FIG. 3, there are 3 display themes including “audio-visual entertainment”, “life encyclopedia”, and “intellectual education” in the desktop. Each display theme has corresponding voice guidance information. For example, the voice guidance information corresponding to the display theme “audio-visual entertainment” includes: “Hello, I'd like to watch movie XX”, “Hello, I'd like to watch YY”. If the user said that “I'd like to watch the drama WW”, then it is a correct voice instruction. A television desktop display apparatus may control the television to play the drama WW after receiving the voice instruction input by the user. For another example, the voice guidance information corresponding to the display theme “intellectual education” includes: “Hello, why are rainbows multicolored”, “Hello, what's the next sentence after before my bed a pool of night”. For another example, the voice guidance information also includes “Hello, next page”, “Hello, last page”, “Hello, variety”. If the user said “Hello, last page”, then it is a correct voice instruction. The television desktop display apparatus may control the television screen to display a previous desktop of the current desktop after receiving the voice instruction input by the user.

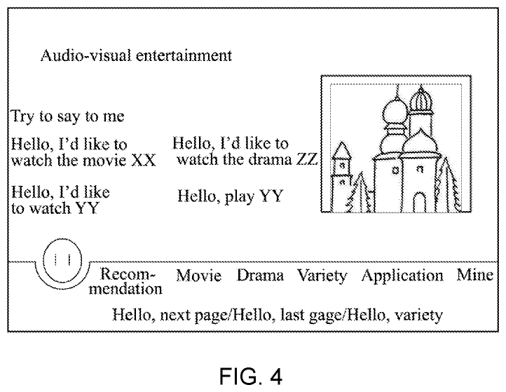

FIG. 4 is another schematic diagram of a desktop provided by an embodiment of the present disclosure. As shown in FIG. 4, there is 1 display theme in the desktop, which is specifically “audio-visual entertainment”. Voice guidance information includes: “Hello, I'd like to watch the movie XX”, “Hello, I'd like to watch the drama ZZ”, “Hello, I'd like to watch YY”, “Hello, play YY”. If the user said “Hello, please play WW”, then it is a correct voice instruction. The television desktop display apparatus may control the television to play the drama WW after receiving the voice instruction input by the user.

In an implementation, the television desktop display method provided by the present embodiment may further include:

receiving voice wake-up words input by the user when a first desktop is displayed currently.

If the voice instruction input by the user is received within a preset time period after woken up, stop displaying multiple desktops circularly and processing the voice instructions.

If the voice instruction input by the user is not received within the preset time period after being woken up, continue displaying the multiple desktops circularly.

Specifically, the voice wake-up word is used to wake up the television desktop display apparatus. The present embodiment does not make limitation to the specific contents of the voice wake-up word, which may be set according to needs. For example, the voice wake-up word may include at least one of the followings: hello, I'd like to, please and the like. The television screen receives the voice wake-up word input by the user and wakes up the television desktop display apparatus when displaying the first desktop currently in the process of displaying multiple desktops circularly. If the voice instruction input by the user is received within a preset time period after the television desktop display apparatus being woken up, the television desktop display apparatus will stop displaying the multiple desktops circularly and process the voice instruction. Subsequently, the television screen may be controlled to display correspondingly according to a processing result of the voice instruction. If the voice instruction input by the user is not received within the preset time period after the television desktop display apparatus being woken up, the television desktop display apparatus will continue displaying the multiple desktops circularly. It should be noted that, the present embodiment does not make limitation to the specific value of the preset time period.

It should be noted that, the voice wake-up words input by the user and the voice instruction input by the user may be input at the same time. For example, in the schematic examples described above, when the user said “Hello, please play WW”, “Hello” is the voice wake-up word and, simultaneously, it can be determined that the voice instruction input by the user is to play the WW according to the voice information “Hello, please play WW”.

It can be seen that, a voice interaction mode between the user and a device is realized through receiving the voice wake-up word and the voice instruction input by the user. Compared with the interaction mode using the remote controller, realizing the human-machine interaction through a mode of human-machine conversation further improves the human-machine interaction effect and the interaction efficiency, and improves user experience.

In an implementation, for the television desktop display method provided by the present embodiment, in S202, acquiring multiple desktops and display time corresponding to the multiple desktops respectively according to the desktop display instructions, may include:

acquiring a desktop display rule according to the desktop display instruction; and

acquiring the multiple desktops and the display time corresponding to the multiple desktops respectively according to the desktop display rule.

Specifically, the desktop display rule may be acquired according to the desktop display instruction. Different desktop display rules may be applied in different application scenarios. Acquiring the multiple desktops and the display time according to the multiple desktops respectively according to the desktop display rule, improves a correlation among the desktop display, the scenario application and the user, so that the acquired multiple desktops may hit contents that the user is interested in with a high probability, thereby further improving the human-machine interaction effect and improving user experience.

It should be noted that, the present embodiment does not make limitation to the desktop display rule. In an implementation, the desktop display rule includes at least one of the followings: displaying according to a default display desktop, displaying according to historical viewing information of a user, displaying according to historical search information of a user, displaying according to preference information of a user, and displaying according to user portrait information of a user. Where, the displaying according to a default display desktop may be displaying according to preset multiple desktops and preset display time of each desktop, which is simple and easy to implement. The present embodiment does not make limitation to the number, the specific modes and the specific duration of the display time corresponding to the preset desktops. Where, the displaying according to historical viewing information of a user may reflect the contents that the user often watch, and interested in within a certain period of time. The displaying according to historical search information of a user may reflect the contents that the user often search proactively within a certain period of time. The displaying according to preference information of a user may reflect the contents that the user is interested in. The displaying according to user portrait information of a user may improve a correlation degree with the user. The present embodiment does not make limitation to the specific content included in the user portrait information. For example, the user portrait information may include the sex, age, education, workplace, etc. The different display rules may be applied in different scenarios. For example, it may be determined according to the desktop display instruction that the desktop display rule is displaying according to the default display desktop or displaying according to the user portrait information of the user when the television desktop display apparatus is initially powered on or changes from the standby state to the working state, which is simple and easy to perform, and thus the television desktop display time is shortened and the booting speed is improved. For another example, in a scenario of returning bake to the display desktop from the normal working state, it can be determined according to the desktop display instruction that the desktop display rule may be any of the followings: displaying according to historical viewing information of the user, displaying according to historical search information of the user, and displaying according to preference information of the user, which improves the probability that the desktop hits user needs, recommends the contents with a highest probability of interacting with the user, and improves the human-machine interaction effect.

In an implementation, acquiring the multiple desktops and the display time corresponding to the multiple desktops respectively according to the desktop display rule may include:

acquiring multiple display themes and a hit rate corresponding to each display theme according to the desktop display rule. The hit rate used to indicate the probability that the user chooses the display themes.

The multiple desktops and the display time corresponding to the multiple desktops respectively are acquired according to the multiple display themes, the hit rate corresponding to each display theme and preset desktop display templates. Where, the desktop includes at least one display theme.

Specifically, the multiple display themes are acquired according to different desktop display rules. Each display theme has a corresponding hit rate. The multiple display themes are allocated to different desktops in accordance with the preset desktop display templates according to the hit rate corresponding to each display theme respectively, thus the multiple desktops and the display time corresponding to the multiple desktops respectively may be acquired. Acquiring the multiple desktops and the display time corresponding to the multiple desktops respectively by using the hit rate, may further improve the probability that the desktop contents hit the contents that the user is interested in, and thus improve the human-machine interaction effect, and improve the user experience.

The display themes and the display templates will be illustratively described below in combination with FIG. 3 and FIG. 4.

In FIG. 3, there are three display themes including “audio-visual entertainment”, “life encyclopedia” and “intellectual education” in the desktop. In FIG. 4, there is one display theme in the desktop which is “audio-visual entertainment” specifically. The desktop display template of the desktop shown in FIG. 3 may include multiple display themes, and the desktop display template of the desktop shown in FIG. 4 may include one display theme.

It should be noted that, the present embodiment does not make limitation to the specific contents of the display theme or the specific modes of the preset desktop display templates.

In an implementation, acquiring display time corresponding to multiple desktops respectively may include:

determining the display time of the desktop display templates corresponding to the multiple desktops respectively as the display time corresponding to the multiple desktops respectively.

The followings are exemplary illustrations still using FIG. 3 and FIG. 4 as the examples. Each preset desktop display template has corresponding display time, and the present embodiment does not make limitation to the specific value of the display time. For example, since the desktop display template shown in FIG. 3 includes multiple display themes, while the desktop display template shown in FIG. 4 merely includes one display theme, the display time corresponding to the desktop display template shown in FIG. 3 may be longer than that in FIG. 4.

The present embodiment provides the television desktop display method including: receiving the desktop display instruction, acquiring multiple desktops and the display time corresponding to the multiple desktops respectively according to the desktop display instruction; and displaying the multiple desktops circularly according to the display time corresponding to the multiple desktops respectively. The television desktop display method provided by the present embodiment may display the multiple desktops circularly according to the display time corresponding to the multiple desktops respectively. In the process of displaying the television desktops, the recommendation form of continuous infinite automatic browsing by taking the desktop as a switch unit may be achieved, which enables the user to browse the television desktops continuously without any interaction, thereby improving human-machine interaction effect and improving user experience.

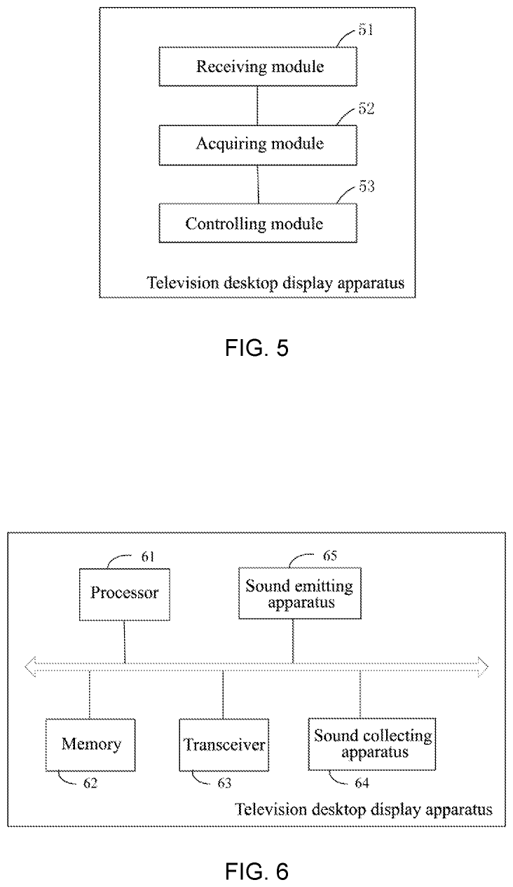

FIG. 5 is a schematic structural diagram of a television desktop display apparatus provided by Embodiment 1 of the present disclosure. The television desktop display apparatus provided by the present embodiment is used to execute the television desktop display method provided by the embodiments shown in FIG. 2 to FIG. 4. As shown in FIG. 5, the television desktop display apparatus provided by the present embodiment may include:

a receiving module 51, configured to receive desktop display instructions;

an acquiring module 52, configured acquire multiple desktops and display time corresponding to the multiple desktops respectively according to the desktop display instruction;

a controlling module 53, configured to display the multiple desktops circularly according to the display time corresponding to the multiple desktops respectively.

In an implementation, the desktop includes voice guidance information, the voice guidance information is used to guide a user to input voice instruction.

In an implementation, the receiving module 51 is further configured to receive a voice wake-up word input by the user when a first desktop is currently displayed;

the controlling module 53 is further configured to, if voice instruction input by the user is received within a preset time period after being woken up, stop displaying the multiple desktops circularly and process the voice instruction.

In an implementation, the controlling module 53 is further configured to:

if the voice instruction input by the user is not received within the preset time period after being woken up, continue displaying the multiple desktops circularly.

In an implementation, the acquiring module 52 is specifically configured to:

acquire a desktop display rule according to the desktop display instructions;

acquire the multiple desktops and the display time corresponding to the multiple desktops respectively according to the desktop display rule.

In an implementation, the acquiring module 52 is specifically configured to:

acquire multiple display themes and a hit rate corresponding to each display theme according to the desktop display rule; the hit rate used to indicate the probability that the user chooses the display theme;

acquire the multiple desktops and display time corresponding to the multiple desktops respectively according to the multiple display themes, the hit rate corresponding to each display theme and preset desktop display templates; where, the desktop includes at least one of the display theme.

In an implementation, the acquiring module 52 is specifically configured to:

determine the display time of the desktop display templates corresponding to the multiple desktops respectively as the display time corresponding to the multiple desktops respectively.

In an implementation, the desktop display rule includes at least one of the followings: displaying according to a default display desktop, displaying according to historical viewing information of the user, displaying according to historical search information of the user, displaying according to preference information of the user, and displaying according to user portrait information of the user.

The television desktop display apparatus provided by the present embodiment is used to execute the television desktop display method provided by the embodiments shown in FIG. 2 to FIG. 4, which has similar specific implementations and technical effect, and will not be repeated herein.

FIG. 6 is a schematic structural diagram of a television desktop display apparatus provided by Embodiment 2 of the present disclosure. As shown in FIG. 6, the television desktop display apparatus may include a processor 61 and a memory 62. The memory 62 is used to store program instructions, and the processor 61 is used to execute the instructions stored in the memory 62, so that the television desktop display apparatus executes the television desktop display method provided by embodiments shown in FIG. 2 to FIG. 4, which has similar specific implementations and technical effect, and will not elaborate herein. The television desktop display apparatus may also include: a transceiver 63, a sound collecting apparatus 64 and a sound emitting apparatus 65. The transceiver 63 is used to communicate with other devices.

Those ordinary skilled in the art may understand that: all or part of the steps for implementing the embodiments of the method mentioned above may be accomplished by hardware related to program instructions. The aforementioned program may be stored in a computer readable storage medium. The program can execute steps including embodiments of the method mentioned above when executed; and the aforementioned storage media includes: a ROM, a RAM, a diskette or an optical disk and other media that may store program code.

Finally, it should be noted that the above embodiments are used merely to illustrate the technical solutions of the embodiments of the present disclosure, not to limit them; although the embodiments of the present disclosure are described in detail with reference to the foregoing embodiments, those ordinary skilled in the art should understand that they may still modify the technical solutions denoted in the embodiments foregoing, or substitute equivalently part or all of the technical features; and these modifications or substitutions do not deviate the essence of the corresponding technical solutions from the scope of the technical solutions in the embodiments of the present disclosure.

What is claimed is:

1. A television desktop display method, comprising:
receiving desktop display instruction;
acquiring multiple desktops and display time corresponding to the multiple desktops respectively according to the desktop display instruction; and
displaying the multiple desktops circularly according to the display time corresponding to the multiple desktops respectively.

2. The method according to claim 1, wherein the desktop comprises voice guidance information, the voice guidance information is used to guide a user to input voice instruction.

3. The method according to claim 1, further comprising:
receiving voice wake-up words input by a user when a first desktop is currently displayed; and
if voice instruction input by the user is received within a preset time period after being woken up, stopping displaying the multiple desktops circularly and processing the voice instruction.

4. The method according to claim 3, further comprising:
if the voice instruction input by the user is not received within the preset time period after being woken up, continuing displaying the multiple desktops circularly.

5. The method according to claim 1, wherein the acquiring multiple desktops and display time corresponding to the multiple desktops respectively according to the desktop display instruction, comprising:
acquiring a desktop display rule according to the desktop display instruction; and
acquiring the multiple desktops and the display time corresponding to the multiple desktops respectively according to the desktop display rule.

6. The method according to claim 5, wherein the acquiring the multiple desktops and the display time corresponding to the multiple desktops respectively according to the desktop display rule, comprising:
acquiring multiple display themes and a hit rate corresponding to each display theme according to the desktop display rule, the hit rate is used to indicate a probability that a user chooses the display theme; and
acquiring the multiple desktops and the display time corresponding to the multiple desktops respectively according to the multiple display themes, the hit rate corresponding to each display theme and preset desktop display templates, wherein the desktop comprises at least one of the display themes.

7. The method according to claim 6, wherein the acquiring display time corresponding to multiple desktops respectively, comprising:
determining the display time of the desktop display templates corresponding to the multiple desktops respectively as the display time corresponding to the multiple desktops respectively.

8. The method according to claim 5, wherein the desktop display rule comprises at least one of the followings: displaying according to a default display desktop, displaying according to historical viewing information of a user, displaying according to historical search information of a user, displaying according to preference information of a user, and displaying according to user portrait information of a user.

9. A television desktop display apparatus, wherein comprising:
a memory and a processor;
the memory is configured to store program instructions;
the processor is configured to invoke the program instructions stored in the memory to:
receive desktop display instruction;
acquire multiple desktops and display time corresponding to the multiple desktops respectively according to the desktop display instruction; and
display the multiple desktops circularly according to the display time corresponding to the multiple desktops respectively.

10. The apparatus according to claim 9, wherein the desktop comprises voice guidance information, the voice guidance information is used to guide a user to input voice instruction.

11. The apparatus according to claim 9, wherein the processor is further configured to invoke the program instructions stored in the memory to:
receive voice wake-up words input by a user when a first desktop is currently displayed;
if voice instruction input by the user is received within a preset time period after being woken up, stop displaying the multiple desktops circularly and process the voice instruction.

12. The apparatus according to claim 11, wherein the processor is further configured to invoke the program instructions stored in the memory to:
if the voice instruction input by the user is not received within the preset time period after being woken up, continue displaying the multiple desktops circularly.

13. The apparatus according to claim 9, wherein the processor is further configured to invoke the program instructions stored in the memory to:
acquire a desktop display rule according to the desktop display instruction; and
acquire the multiple desktops and the display time corresponding to the multiple desktops respectively according to the desktop display rule.

14. The apparatus according to claim 10, wherein the processor is further configured to invoke the program instructions stored in the memory to:
acquire a desktop display rule according to the desktop display instruction; and
acquire the multiple desktops and the display time corresponding to the multiple desktops respectively according to the desktop display rule.

15. The apparatus according to claim 11, wherein the processor is further configured to invoke the program instructions stored in the memory to:
acquire a desktop display rule according to the desktop display instruction; and
acquire the multiple desktops and the display time corresponding to the multiple desktops respectively according to the desktop display rule.

16. The apparatus according to claim 12, wherein the processor is further configured to invoke the program instructions stored in the memory to:
acquire a desktop display rule according to the desktop display instruction; and
acquire the multiple desktops and the display time corresponding to the multiple desktops respectively according to the desktop display rule.

17. The apparatus according to claim 13, wherein the processor is further configured to invoke the program instructions stored in the memory to:
acquire multiple display themes and a hit rate corresponding to each display theme according to the desktop display rule, the hit rate is used to indicate a probability that a user chooses the display theme; and
acquire the multiple desktops and the display time corresponding to the multiple desktops respectively according to the multiple display themes, the hit rate corresponding to each display theme and preset desktop display templates; wherein the desktop comprises at least one of the display themes.

18. The apparatus according to claim 14, wherein the processor is further configured to invoke the program instructions stored in the memory to:
determine the display time of the desktop display templates corresponding to the multiple desktops respectively as the display time corresponding to the multiple desktops respectively.

19. The apparatus according to claim 13, wherein the desktop display rule comprises at least one of the followings: displaying according to a default display desktop, displaying according to historical viewing information of a user, displaying according to historical search information of a user, displaying according to preference information of a user, and displaying according to user portrait information of a user.

20. A non-volatile storage medium, comprising: a readable storage medium and a computer program, the computer program is used to implement the television desktop display method according to claim 1.
